(19) United States
(12) Patent Application Publication
(10) Pub. No.: US 2014/0198186 A1
(43) Pub. Date: Jul. 17, 2014

(54) 3D IMAGE GENERATING DEVICE

(71) Applicants: Yu-Chou Yeh, Taoyuan (TW); Ting-Ching Lin, Taoyuan (TW); Kun-Ming Chang, Taoyuan (TW)

(72) Inventors: Yu-Chou Yeh, Taoyuan (TW); Ting-Ching Lin, Taoyuan (TW); Kun-Ming Chang, Taoyuan (TW)

(73) Assignee: J TOUCH Corporation, Taoyuan County (TW)

(21) Appl. No.: 13/739,247

(22) Filed: Jan. 11, 2013

(51) Int. Cl. H04N 13/02

(52) U.S. Cl. CPC H04N 13/0228
USPC 348/49

(57) ABSTRACT

A 3D image generating device is provided and includes: a lenticular plate storage chamber for storing a plurality of lenticular plates; a picture-taking device for taking a picture of an object to generate an object image; an image processing unit for capturing and processing the object image of the object to generate a front-view object image and combining the front-view object image with a rear-view image to generate a synthetic 3D image; a lenticular plate conveying unit for moving the lenticular plates inside the lenticular plate storage chamber to a printing device; a memory unit for storing at least one rear-view image; the printing device for printing the synthetic 3D image on a flat surface of the lenticular plate; and a controlling unit for controlling operation of the picture-taking device, the image processing unit, the memory unit, the printing device, and the lenticular plate conveying unit.

### FIELD OF THE INVENTION

The present invention relates to 3D image generating devices, and more particularly, to a device for producing 3D photos.

### BACKGROUND OF THE INVENTION

U.S. Published Patent Application US2004/0114193A1, entitled Photo Sticker Vending Machine And Method, Photo Sticker And Photo Sticker Unit, discloses a photo sticker vending machine capable of printing photo stickers. However, US2004/0114193A1 has a drawback, that is, the photo sticker vending machine of US2004/0114193A1 is not capable of printing 3D image photos.

Conventional photo sticker making devices are intended mostly for producing small-sized photo stickers but are incapable of producing large-sized photo stickers, especially large-sized 3D image photo stickers.

In view of the aforesaid drawbacks of the conventional related devices, the inventor of the present invention conceived room for improvement in the prior art and thus developed a 3D image generating device which overcomes the aforesaid drawbacks.

### SUMMARY OF THE INVENTION

It is an objective of the present invention to provide a 3D image generating device capable of producing 3D image photos automatically.

In order to achieve the above and other objectives, the present invention provides a 3D image generating device, comprising: a lenticular plate storage chamber for storing at least a lenticular plate having a flat surface and a lenticular len structure surface opposing the flat surface. A picture-taking device for taking a picture of an object to generate an object image. An image processing unit for capturing and processing the object image of the object to generate a front-view object image and combining the front-view object image with a rear-view image to generate a synthetic 3D image. A memory unit for storing at least one rear-view image; a printing device for printing the synthetic 3D image on the flat surface of the lenticular plate. A lenticular plate conveying unit for moving the lenticular plate inside the lenticular plate storage chamber to the printing device, the lenticular plate conveying unit comprising: a fetching device for fetching the lenticular plate inside the lenticular plate storage chamber; and a displacing device for moving the fetching device to thereby move the lenticular plate fetched by the fetching device onto the printing device. A controlling unit for controlling operation of the picture-taking device, the image processing unit, the memory unit, the printing device, and the lenticular plate conveying unit.

### BRIEF DESCRIPTION OF THE DRAWINGS

Objectives, features, and advantages of the present invention are hereunder illustrated with specific embodiments in conjunction with the accompanying drawings, in which:

FIG. 1A is a schematic view of a 3D image generating device according to the present invention;

FIG. 1B is a schematic view of the 3D image generating device fetching a lenticular plate according to the present invention;

FIG. 1C is a schematic view of the 3D image generating device positioning the lenticular plate thus fetched on a printing device according to the present invention;

FIG. 2A is a perspective view of the lenticular plate which has not yet printed with a synthetic 3D image according to the present invention;

FIG. 2B is a perspective view, from another angle of view, of the lenticular plate which has not yet printed with a synthetic 3D image according to the present invention;

FIG. 3 is a schematic exemplary picture of a synthetic 3D image obtained after being processed by an image processing unit according to the present invention; and

FIG. 4 is a schematic lateral view of the lenticular plate printed with a synthetic 3D image by the 3D image generating device according to the present invention.

### DETAILED DESCRIPTION OF THE EMBODIMENTS

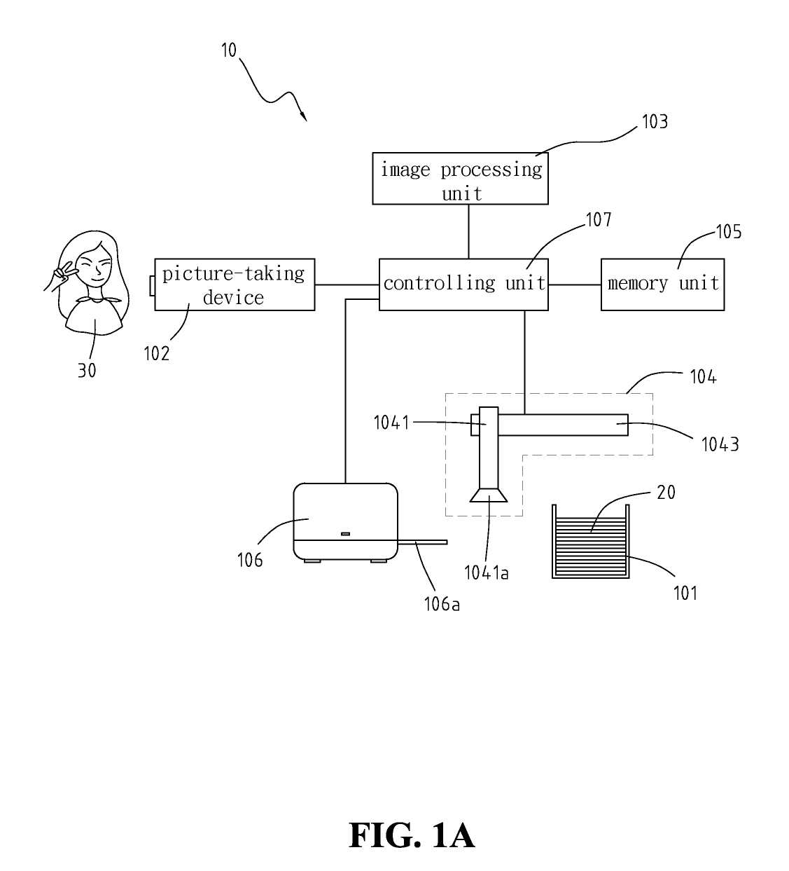

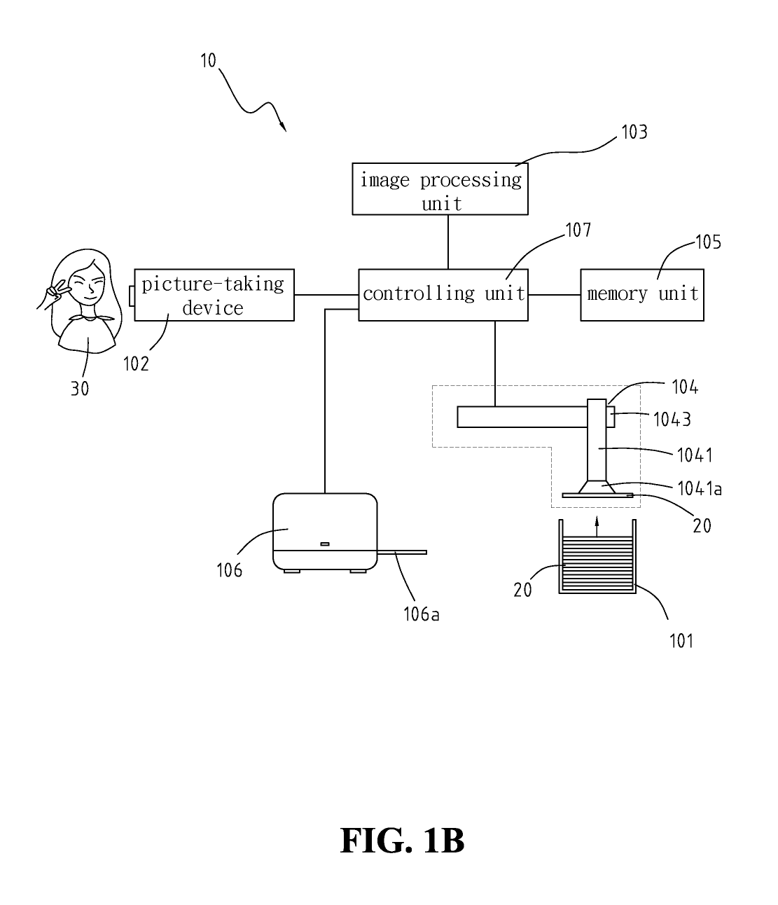

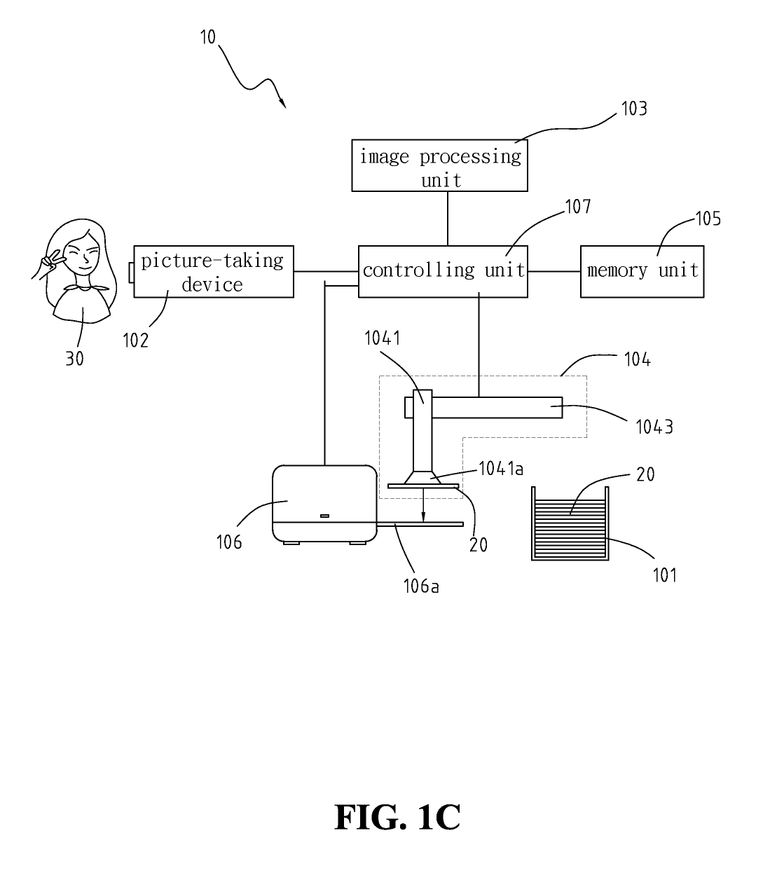

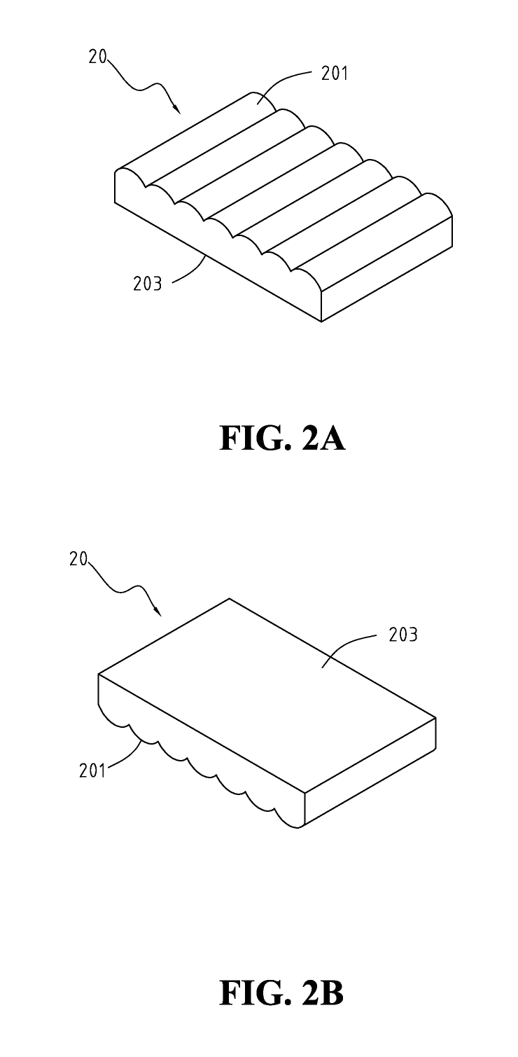

Referring to FIGS. 1A˜1C and FIGS. 2A˜2B, the present invention provides a 3D image generating device 10 capable of producing 3D photos. In a specific embodiment, the 3D image generating device 10 is a 3D photo sticker generator. Referring to FIGS. 2A-2B, the present invention provides a lenticular plate 20 which has a lenticular len structure and is capable of generating 3D images and thereby producing 3D photos. The lenticular plate 20 has a lenticular len structure surface 201 fully covered with substantially semicircular cylindrical lenses arranged consecutively. The other surface of the lenticular plate 20 is a flat surface 203. The 3D image generating device 10 of the present invention comprises a lenticular plate storage chamber 101, a picture-taking device 102, an image processing unit 103, a lenticular plate conveying unit 104, a memory unit 105, a printing device 106, and a controlling unit 107, which are described as follow.

The lenticular plate storage chamber 101 stores at least one lenticular plate 20. The lenticular plate storage chamber 101 is a chamber-like structure with an opening.

The picture-taking device 102 takes a picture of an object 30 to generate an object image. For example, the picture-taking device 102 is a digital camera or an image-capturing device including a CMOS light-sensing component or a CCD light-sensing component. For example, the object 30 is a human being, an article, an animal, or a plant. The object 30 is positioned in front of the picture-taking device 102. As soon as the picture-taking device 102 takes a picture of the object 30, the picture-taking device 102 generates the object image. Afterward, the object image is sent to the controlling unit 107 and eventually to the image processing unit 103. Preferably, the picture-taking scenario is monochromic, such that the object 30 can be easily identified from the object image.

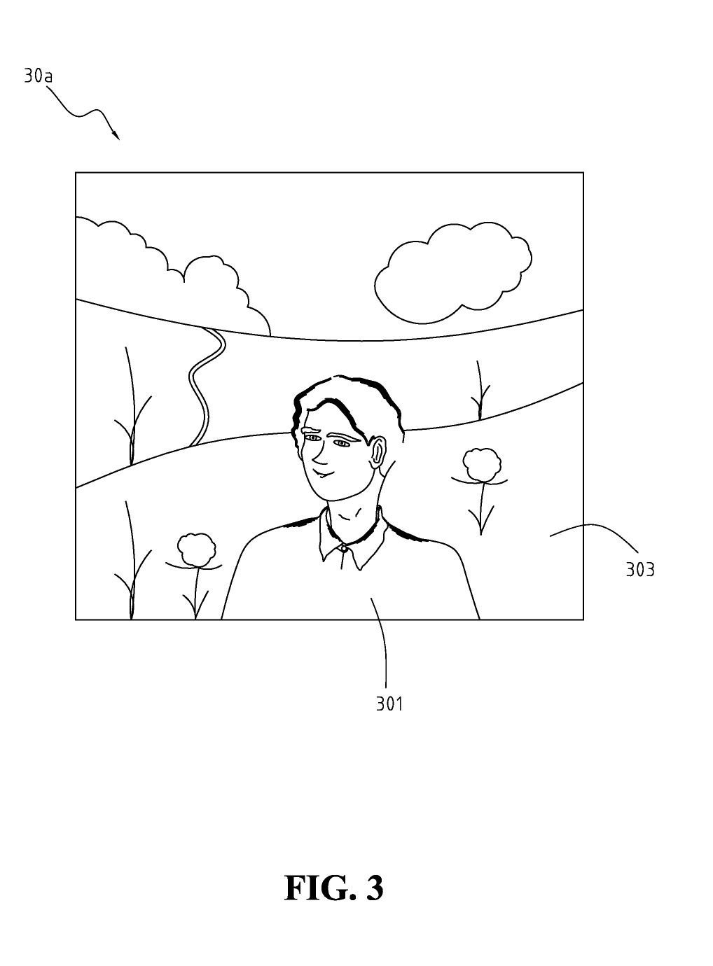

Referring to FIG. 3, the image processing unit 103 captures and processes the object image pertaining to the object 30 so as to generate a front-view object image 301. Furthermore, the image processing unit 103 combines the front-view object image 301 with a rear-view image 303 so as to generate a synthetic 3D image 30a. The image processing unit 103 can access the memory unit 105 for a specified rear-view image 303 or for a non-specified rear-view image 303. The image processing unit 103 essentially has the image capturing function and the 3D image synthesis function. The image capturing function involves removing a portion of the object image to thereby capture only the image of the object 30. For example, the image capturing function involves capturing an image of the object 30, for example, capturing an image of a human being, an article, an animal, or a plant (for example, when the human being shown in FIG. 3 is regarded as the object), and then processing the image thus captured to generate the front-view object image 301.

The 3D image synthesis function involves combining the front-view object image 301 with the rear-view image 303 to generate the synthetic 3D image 30a. To this end, the front-view object image 301 is combined with the rear-view image 303 in accordance with predetermined information pertaining to the depth of field of the object 30, parameters of the lenticular plate 20, and parameters of the printing device 106, so as to perform 3D image synthesis. The process of 3D image synthesis entails: positioning a front-view object and a rear-view image oppositely, down-scaling, sampling images and arranging the images alternately, and outputting the synthetic 3D image 30a fit to be printed on the lenticular plate 20.

Specific examples of the image processing unit 103 include but are not limited to a graphic processing chip. The image capturing function and the 3D image synthesis function can be performed according to the related prior art and by a conventional related image processing software means, a conventional related image processing firmware means, or a conventional related image processing hardware means.

One of the purposes of the lenticular plate conveying unit 104 is to move the lenticular plate 20 inside the lenticular plate storage chamber 101 to the printing device 106. The lenticular plate conveying unit 104 comprises a fetching device 1041 and a displacing device 1043. The fetching device 1041 fetches the lenticular plate 20 from the lenticular plate storage chamber 101. Specific examples of the fetching device 1041 include but are not limited to a vacuum sucker 1041a, a vacuum valve (not shown), and a pump (not shown).

Referring to FIG. 1B, the displacing device 1043 moves the fetching device 1041 into the lenticular plate storage chamber 101. As soon as the vacuum sucker 1041a comes into contact with the uppermost lenticular plate 20 inside the lenticular plate storage chamber 101, the pump withdraws air from between the vacuum sucker 1041a and the lenticular plate 20; afterward, both the pump and the vacuum valve are turned off. In doing so, the vacuum sucker 1041a grips the lenticular plate 20 by suction. Referring to FIG. 1C, as soon as the displacing device 1043 moves the fetching device 1041 to an input end 106a of the printing device 106, the vacuum valve is turned on, and the vacuum sucker 1041a lets the lenticular plate 20 go, thereby positioning the lenticular plate 20 on the printing device 106.

Once the printing device 106 finishes printing, the displacing device 1043 will move the fetching device 1041 to the input end 106a of the printing device 106. As soon as the vacuum sucker 1041a comes into contact with the lenticular plate 20 at the input end 106a, the pump withdraws air from between the vacuum sucker 1041a and the lenticular plate 20, and then both the pump and the vacuum valve are turned off. Afterward, the displacing device 1043 moves the fetching device 1041 to a predetermined position (such as a photo outlet) and then releases the lenticular plate 20.

The memory unit 105 stores at least one rear-view image 303. When provided in plurality, the rear-view images 303 differ in image contents. Specific examples of the memory unit 105 include but are not limited to a memory, a memory card, a hard disk drive, and any other storage devices. The rear-view images 303 are obtained by generating multiple images taken from different angles of view with a single-lens digital camera in a sliding motion, by generating multiple images with a multiple-lens digital camera, or by converting a single image into multiple images with a 2D-to-3D conversion program. The images correspond in quantity to the angles of view from which the images are observed.

The printing device 106 prints the synthetic 3D image 30a on the flat surface 203 of the lenticular plate 20. A specific example of the printing device 106 is a conventional thermal transfer printing device. A specific example of the input end 106a of the printing device 106 is a tray.

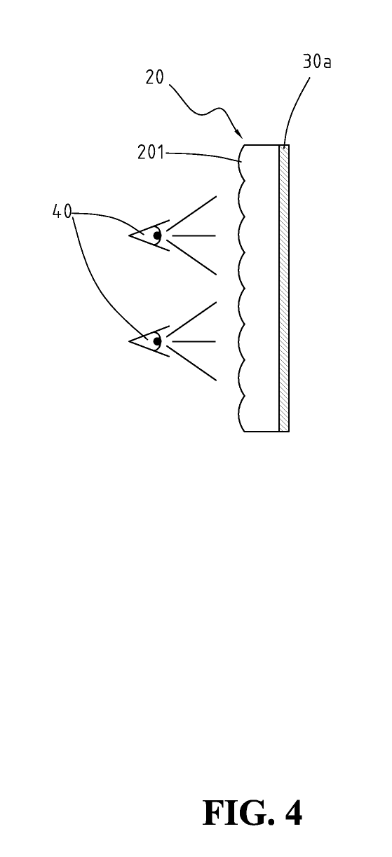

The controlling unit 107 controls the picture-taking device 102, the image processing unit 103, the lenticular plate conveying unit 104, the memory unit 105, and the printing device 106 in a manner to enable the 3D image generating device 10 to produce 3D image photos automatically as shown in FIG. 4. In a specific embodiment, the controlling unit 107 comprises a processor and a custom chip. The processor executes the automatic production process of the 3D image photos. The custom chip is in charge of the operation of the lenticular plate conveying unit 104.

Referring to FIG. 4, after passing the lenticular len structure surface 201, the synthetic 3D image 30a printed on the lenticular plate 20 is perceived by both eyes 40, wherein different images are formed at the right eye and the left eye, respectively, to thereby bring about a 3D image effect.

In practice, the lenticular plate 20 is a conventional lenticular plate and is preferably made of a material of a high degree of transparency. According to the present invention, if the 3D image generating device 10 is equipped with a large-sized printing device 106, the lenticular plate 20 can be a large-sized lenticular plate, so as to produce large-sized 3D image photos.

The 3D image generating device 10 of the present invention further comprises a display screen (not shown) electrically connected to the controlling unit 107 and adapted to display an operating frame.

The 3D image generating device 10 of the present invention produces 3D image photos automatically and prints the synthetic 3D image 30a on the surface of the lenticular plate 20 directly. Hence, the present invention involves an inventive step.

Hence, the present invention meets the three requirements of patentability, namely novelty, non-obviousness, and industrial applicability.

The present invention is disclosed above by preferred embodiments. However, persons skilled in the art should understand that the preferred embodiments are illustrative of the present invention only, but should not be interpreted as restrictive of the scope of the present invention. Hence, all equivalent changes and modifications made to the claims and aforesaid embodiments should fall within the scope of the present invention.

What is claimed is:

1. A 3D image generating device, comprising:
a lenticular plate storage chamber for storing at least one lenticular plate having a flat surface and a lenticular len structure surface opposing the flat surface;
a picture-taking device for taking a picture of an object to generate an object image;
an image processing unit for capturing and processing the object image of the object to generate a front-view object image and combining the front-view object image with a rear-view image to generate a synthetic 3D image;
a memory unit for storing at least one said rear-view image;
a printing device for printing the synthetic 3D image on the flat surface of the lenticular plate;
a controlling unit for controlling operation of the picture-taking device, the image processing unit, the memory unit, the printing device, and a lenticular plate conveying unit;
the lenticular plate conveying unit for moving the lenticular plate inside the lenticular plate storage chamber to the printing device, wherein the lenticular plate conveying unit comprising:
a fetching device for fetching the lenticular plate inside the lenticular plate storage chamber; and
a displacing device for moving the fetching device to thereby move the lenticular plate fetched by the fetching device onto the printing device.

2. The 3D image generating device of claim 1, further comprising a display screen electrically connected to the controlling unit and adapted to display an operating frame.

3. The 3D image generating device of claim 1, wherein the fetching device comprises a vacuum sucker, a vacuum valve, and a pump.

4. The 3D image generating device of claim 1, wherein the printing device is a thermal transfer printing device.

5. The 3D image generating device of claim 1, wherein the picture-taking device is a digital camera or an image-capturing device including a CMOS light-sensing component or a CCD light-sensing component.

6. The 3D image generating device of claim 1, wherein the displacing device moves the fetching device, such that the fetching device fetches the printed lenticular plate positioned on the printing device.
